(19) United States
(12) Patent Application Publication
(10) Pub. No.: US 2017/0303534 A1
(43) Pub. Date: Oct. 26, 2017

(54) METHOD FOR REDUCING VOLATILE EMISSIONS FROM SOIL FUMIGATION

(71) Applicant: Actagro, LLC, Fresno, CA (US)

(72) Inventors: Thomas J. GERECKE, Visalia, CA (US); Husein AJWA, Salinas, CA (US); Gregory A. CRAWFORD, Fresno, CA (US); Taha REZAI, Clovis, CA (US); John BREEN, Fresno, CA (US); Montell L. BAYER, Fresno, CA (US)

(21) Appl. No.: 15/520,404

(22) PCT Filed: Oct. 19, 2015
(86) PCT No.: PCT/US2015/056270

§ 371 Date: Apr. 19, 2017

Related U.S. Application Data
(60) Provisional application No. 62/066,110, filed on Oct. 20, 2014.

(51) Int. Cl. A01N 25/32; A01N 25/18; A01N 33/18; A01N 37/34

(52) U.S. Cl. CPC A01N 25/32; A01N 37/34; A01N 25/18; A01N 33/18; A01N 2300/00

(57) ABSTRACT

This disclosure relates to a method for controlling the rate at which volatile organic compounds from a soil fumigant are emitted from soil, and, more particularly, to a method for reducing emissions of an applied fumigant in the soil so that fumigant efficacy and safety are improved, and unwanted environmental effects are reduced.

### CROSS-REFERENCE TO RELATED APPLICATION

This application is a U.S. National Stage Application under 35 U.S.C. §371 of International Application No. PCT/US2015/056270, filed Oct. 19, 2015, which application claims the benefit under 35 U.S.C. §119 of U.S. Application No. 62/066,110, filed Oct. 20, 2014, the contents of each is hereby incorporated by reference in its entirety.

### FIELD

This disclosure relates to a method for controlling the rate at which volatile organic compounds from a soil fumigant are emitted from soil, and, more particularly, to a method for reducing emissions of an applied fumigant in the soil so that fumigant efficacy and safety are improved, and unwanted environmental effects are reduced.

### BACKGROUND

Soil fumigants are used in agriculture to control soil pests, such as nematodes and plant pathogens. According to the U.S. Environmental Protection Agency, more than 100 million pounds of these products are applied annually in the U.S., and of the top 13 most commonly used pesticides, five of them are soil fumigants. For many years methyl bromide (MeBr) was widely used as a soil fumigant for agricultural planting sites. Due to its adverse environmental effects, and especially its depletion of stratospheric ozone, the use of MeBr as a fumigant has been largely discontinued and that chemical has been replaced by other fumigants including chloropicrin, 1,3-dicholorpropene and methyl isothiocyanate generators such as metam sodium and dazomet. Nonetheless, many of these alternative fumigants have certain safety concerns. They are strictly regulated as volatile organic compounds (VOCs), because they are applied as liquids which are released in gaseous form over time into the atmosphere. Such release into the atmosphere shortens the time that the fumigant remains present in the soil which, in turn, reduces the effectiveness of the fumigant in controlling soil pests and pathogens. The released VOC's also present an environmental and safety hazard that has necessitated the promulgation of strict governmental regulations controlling the use of conventional fumigants. Use limits and environmental buffer zones have been mandated to limit the risks posed by the released VOCs. Film tarps comprising polyethylene, virtually impermeable film (VIF) and totally impermeable film (TIF) are commonly utilized to delay volatilization or “gassing off” of VOC fumigants from the fumigant soil. Nonetheless, the tarp covered fumigant continues to diffuse and dissipate from the soil, particularly when the air temperature is high. Typically, within 7-14 days after a fumigant is applied, an effective level of the product no longer remains in the soil. Moreover, films and tarps are logistically time consuming, complicated and costly to install and remove, and since they cannot be recycled, they are disposed as solid waste in landfills.

Various alternative approaches have been taken to reduce the rate of fumigant emissions from agricultural soils. Plastic mulches have been applied to the soil, but these products, and the labor needed to install them, tend to be quite expensive and wasteful. Equipment has been developed to increase the fumigant injection depth, but the techniques utilizing such equipment tend to leave the upper surface of the soil untreated or inadequately treated. Water-based soil caps have been employed to slow diffusion of the fumigant into the air. Alternatively, the fertilizer potassium thiosulfate has been applied to the soil to break down the applied fumigant and expedite its dispersion through the soil. Targeted application of fumigants directly under the planted crops has also been attempted. Manure and composts have been added in bulk to at least intermittently reduce fumigant emissions. VOCs tend to be readily incorporated into the applied organic material.

To date, none of the foregoing methods optimally eliminates all of the safety hazards and environmental risks caused by the “gassing off” or volatilization of soil fumigants. Moreover, the known methods for controlling soil fumigant emissions require time, labor, materials and/or equipment, which can significantly increase costs to the grower and ultimately the consumer. The inconvenience and added expense relating to these known techniques may cause the grower to abandon the use of fumigants altogether and opt for less profitable crop choices.

Accordingly, a significant need exists for a method that allows the grower to more effectively and efficiently utilize currently available fumigants while reducing the gaseous VOC emissions and disadvantages that currently accompany the use of these products.

### SUMMARY

Disclosed herein is a simple and convenient method for controlling fumigant volatilization from agricultural soils. The method comprises the application of a volatile organic compound emission reducing substance (VOCERS) to soil and a fumigant to soil within a sufficiently short time period, such that the VOCERS substantially controls the volatilization (and thus loss) of the fumigant.

The method and compositions described herein prolong the retention of fumigants within an agricultural soil and which delays volatilization and “gassing off” of such products so that the soil fumigants act more efficiently and effectively to eradicate soil pests and pathogens.

In one aspect, provided is a method for controlling or reducing emission of a volatile organic compound (VOC) from soil, comprising applying a volatile organic compound emission reducing substance (VOCERS) and a fumigant to soil or applying a volatile organic compound emission reducing substance (VOCERS) to soil which has been treated with a fumigant, wherein the emission of the VOC is reduced by least about 50% by weight compared to untreated soil after at least about 7 days after applying the fumigant at a temperature of about 15-35° C.

In another aspect, provided is a method for controlling or reducing emission of a volatile organic compound (VOC) from soil, comprising applying a volatile organic compound emission reducing substance (VOCERS) and a fumigant to soil or applying a volatile organic compound emission reducing substance (VOCERS) to soil which has been treated with a fumigant, wherein the mass transfer coefficient (MTC) in centimeters/hour of the VOCERS with respect to VOC as detected from the soil surface when fumigant is applied to untreated soil is less than or about 0.4.

In yet another aspect, provided is a method for reducing a buffer zone, comprising applying a volatile organic compound emission reducing substance (VOCERS) and a fumigant to soil or applying a volatile organic compound emission reducing substance (VOCERS) to soil which has been treated with a fumigant, wherein the buffer zone is by at least about 10%.

In the methods described herein, the VOCERS is typically applied to the soil within about 3 hours after applying a fumigant, although in certain instances, the VOCERS is applied to the soil at substantially the same time as the fumigant, or they may even be pre-mixed prior to applying. Accordingly, also provided is a composition comprising a fumigant and a volatile organic compound emission reducing substance (VOCERS).

Also provided is a method for controlling the volatilization and emission of volatile organic compounds from soil fumigants into the atmosphere so that health, safety and environmental problems, which typically accompany such volatilization, are significantly controlled and reduced.

The use of fumigants in combination with a humic component as described herein allows soil fumigants to be applied to agricultural soils under less stringent governmental regulations than traditionally apply to the application of such products, and is simpler, requires less time, labor and equipment and is much less expensive than conventional techniques used for this purpose.

Provided herein is a method for controlling or reducing the atmospheric dissipation of a fumigant and, in particular, the volatilization of volatile organic compounds comprising the fumigant from agricultural soil to which the fumigant is applied. A soil fumigant is applied to the soil of an agricultural field or other planting site. At the same time, shortly or immediately prior thereto or thereafter, a volatile organic compound emission reducing substance (VOCERS) is applied to the soil. In a preferred embodiment, the VOC emission-restricting substance includes a liquid formulation containing a liquid composition of the type produced by the methods described in U.S. Pat. Nos. 4,698,090 and 4,786,307, issued to Marihart.

Also provided is:

(a) a method for significantly improving the efficiency and effectiveness of soil fumigants while improving soil health and greatly reducing the adverse environmental, safety and health impacts commonly caused by soil fumigants;

(b) a method for significantly improving the efficiency of soil fumigants by reducing fumigant waste and making a greater percentage of the fumigant available for attacking pests and pathogens;

(c) a method for reducing the volume and resulting cost of fumigant conventionally required to effectively treat an agricultural field or other planting site; and/or

(d) combining the use of a fumigant with a humic component; comprising applying to the soil:
i) a humic component; and
ii) a fumigant;
wherein the humic component is added to the soil within a time period of from about 3 hours before to about 3 hours after applying the fumigant.

### BRIEF DESCRIPTION OF THE DRAWINGS

FIG. 1 shows a series of tests simulating a shank fumigant application; the test results reflect volatilization levels for various soil fumigants applied to like soil samples and measured a predetermined time after each fumigant was applied to a first soil treated with a water seal alone, a second soil sample treated with a water seal containing a VOCERS (VR-016) and a third soil sample which is untreated (Pic=chloropicrin; Telone=1,3-dichloropropene; DMDS=dimethyl disulfide; MITC=methyl isothiocyanate; and AITC=allyl isothiocyanate). Fumigant concentrations in the air above the soil after injection at a 4-inch depth in soil that was treated with a VOCERS seal (VR-016), water seal, and an untreated control.

FIG. 2 is derived from the results of FIG. 1 and, for each fumigant, compares the volatilization percentages of fumigated soil samples treated with a VOCERS (VR-016) and a water seal, respectively, with the corresponding percentage of the same fumigant that volatilizes from an untreated sample of fumigated soil; volatilization percentages are provided above each bar for the five different fumigants (Pic=chloropicrin; Telone=1,3-dichloropropene; DMDS=dimethyl disulfide; MITC=methyl isothiocyanate; and AITC=allyl isothiocyanate). FIG. 2 is derived from the same data set depicted in FIG. 1.

FIG. 3 shows the mass transfer coefficient (MTC), or speed of volatilization, for various types of fumigants (Pic=chloropicrin; Telone=1,3-dichloropropene; DMDS=dimethyl disulfide; MITC=methyl isothiocyanate; and AITC=allyl isothiocyanate) wherein the fumigated soil has been treated with either a VOCERS (VR-016), a water seal or no seal, respectively, as reflected by the test results shown in FIGS. 1 and 2. A smaller mass transfer coefficient is indicative of slower movement or flow and thus longer and more effective retention of the fumigant within the soil.

FIG. 4 shows the mass transfer coefficient of soil (Elder sandy loam) treated with chloropicrin (Pic) and a) a VOCERS (VR-016) seal, b) water seal, and c) no seal. In each panel of FIG. 4, the upper curve and data points indicate the amount of the fumigant at the injection point in the source chamber (100% at time zero) at different sampling times after fumigant is placed in the source chamber. The lower curve and data points in each figure indicate the amount of fumigant above the soil in the receiving chamber (0% at time zero).

FIG. 5 illustrates the effect of a VOCERS (VR-016) upon the volatility of chloropicrin (Pic) in a simulated chemigation process. Specifically, FIG. 5 shows chloropicrin concentrations in the bottle headspace over four hours after application with and without soil and VR-016.

FIG. 6 shows the effect that the use of a VOCERS (VR-016) has on methyl isothiocyanate (MITC) volatilization when metam-Na (an MITC generator) is employed as a fumigant.

FIG. 7 compares mass transfer coefficients (MTC, cm·hr⁻¹) of fumigants (a) chloropicrin, (b) 1,3-dichloropropene (1,3-D), (c) dimethyl disulfide (DMDS), and (d) methyl isothiocyanate (MITC), passing through the VOCERS (VR-016), compared to representative films covering the soil surface, used in production agriculture, as reported by Qian et al. (see Qian et al. 2011, 45, 9711-9718). Smaller numbers indicate less flow. In the figure, the high and low end of the dotted vertical line represents the high and low end of the range of MTCs for various films in each film group reported by Qian et al., while the solid triangle represents the midpoint of the reported range. In the case of the “Metalized Films” group, the range is too small in all cases to be observed on the Figure. For VR-016, the solid triangle represents the mean of replicated data (see FIG. 3), with no range given.

### DETAILED DESCRIPTION

It is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

### LIST OF ABBREVIATIONS

1,3-D 1,3-Dichloropropene

AITC Allyl isothiocyanate

cm Centimeter

DMDS Dimethyl disulfide

hr Hour

i.d. Inner diameter

Metam-Na Metam sodium

MITC Methyl isothiocyanate

mm Millimeter

MTC Mass transfer coefficients

Pic or CP Chloropicrin

TIF Totally impermeable film

VIF Virtually impermeable film

VOCERS Volatile organic compound emission reducing substance

VOCs Volatile organic compounds

It is noted that as used herein and in the appended claims, the singular forms “a”, “an”, and “the” include plural referents unless the context clearly dictates otherwise. Thus, for example, reference to “a fumigant” includes a plurality of fumigants.

Unless defined otherwise, all technical and scientific terms used herein have the same meaning as commonly understood by one of ordinary skill in the art to which this disclosure belongs. As used herein the following terms have the following meanings.

As used herein, the term “comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) claimed. “Consisting of” shall mean excluding more than trace elements of other ingredients and substantial method steps. Embodiments defined by each of these transition terms are within the scope of this disclosure.

The term “about” when used before a numerical designation, e.g., temperature, time, amount, and concentration, including range, indicates approximations which may vary by (+) or (−) 10%, 5% or 1%.

As used herein, the “volatile organic compound emission reducing substance” or “VOCERS” is intended to refer to a humic substance, which can comprise at least one of the o following components: (1) a composition produced as described in Marihart, U.S. Pat. Nos. 4,698,090 and/or 4,786,307 (the disclosures of which are incorporated herein by reference in their entirety); and/or (2) a humic extract from a genuine humic source, e.g., leonardite. This is described in more detail in the section below.

The terms “fumigant” and “soil fumigant” are used interchangeably and are intended is to refer to agents (e.g., pesticides) that, when applied to soil, form a gas to control pests that live in the soil. Soil fumigants are typically and routinely used on many species of high value crops and provide benefits to growers in controlling a wide range of pests, including nematodes, fungi, bacteria, insects and weeds. In certain embodiments, the fumigant is not a herbicide. The crop can be any plant, for example, a dicot or monocot crop.

In certain embodiments, the fumigant is a volatile organic compound (VOC), which compounds typically have a boiling point at or below at 25° C. Exemplary fumigants include chloropicrin, 1,3-dichloropropene, methyl isothiocyanate generators (e.g., metam sodium), allyl isothiocyanate, methyl bromide, etc. Any fumigant, or combination of one or more fumigant (such as chloropicrin in combination with methyl bromide, and/or 1,3-dichloropropene), intended to eradicate soil pests and/or pathogens may be utilized in the methods disclosed herein. In addition, in instances where the applied fumigant changes chemical form (e.g., by degradation, decomposition, reaction with air or water, etc.), the term “fumigant” may refer to one or more volatile compound(s) generated thereby. For example, the term “fumigant” can refer to metam sodium (metam-Na) and/or methyl isothiocyanate (MITC).

The term “applying” or “applied” to the soil is intended to refer to any suitable method for applying a fumigant and/or a VOCERS to soil. Typically, the fumigant is applied as a liquid or in a liquid composition. In certain embodiments, the fumigant is applied as a liquid, aqueous composition. The fumigant may also be formulated as a solid, e.g. in a granular form, or as a wettable powder. The term is intended to encompass methods for applying liquid, solid, or other form or mixture thereof to the soil. In certain embodiments, the “applying” or “applied” to the soil comprises one or more of spraying, flooding, soil injection and/or chemigation. When used as a seal, the VOCERS can be applied to the surface as a spray, or just below the surface of the soil, as a shank or fumigation. A o subsequent rolling or light cultivation or other compaction of the soil may be employed to help establish the VOCERS seal.

The term “rate of volatilization” is intended to refer to the rate at which a fumigant (or one or more fumigants) is depleted from the soil via volatilization. The fumigant may or may not have broken down or otherwise chemically degraded prior to volatilization. In certain embodiments, the amount of fumigant loss via volatilization is reduced by at least about 50%, or about 40%, or about 30%, or about 20%, or about 10% as compared to fumigant alone. In certain embodiments, the amount of fumigant loss via volatilization is reduced by at least about 50%, or about 40%, or about 30%, or about 20%, or about 10% as compared to fumigant in combination with a tarp (or other agricultural film). Accordingly, in certain embodiments, the methods described herein do not comprise applying an agricultural film to the soil.

The term “untreated soil” is intended to refer to soil which has been treated with a fumigant, but has not been treated with another liquid or solid emission restricting substances and devices, such as salts of thiosulfate, tarps, films, and other soil coverings, made from plastics, polymers, polyethylene, HOPE, resins and similar materials known in the soil fumigation industry to control fumigant volatilization. The term “untreated soil” also refers to soil which has not been treated with water either directly before or after fumigation (e.g., within about 3 hours, or about 1 hour, or 30 minutes, or less). However, certain methods described herein utilize water in combination with the VOCERS, and thus, in certain embodiments, the soil may be treated with water in combination with the fumigant and VOCERS.

Volatile Organic Compound Emission Reducing Substance (VOCERS)

As used herein, the volatile organic compound emission reducing substance (VOCERS) includes a liquid formulation containing at least one of the following components:

(1) a composition produced as described in Marihart, U.S. Pat. Nos. 4,698,090 and/or 4,786,307 (the disclosures of which are incorporated herein by reference in their entirety); and/or

(2) a humic extract from a genuine humic source, e.g., leonardite.

In some embodiments, the VOCERS comprises a combination of Component 1 and Component 2, each at one to three parts by weight.

The humic extract (Component 2 above) can comprise any humic substance, including Component 1. For example, it can comprise one or more of a humic composition produced as described in Marihart (see, U.S. Pat. Nos. 4,698,090 and 4,786,307, the disclosures of which are incorporated herein by reference), or a humic substance (HS) is comprising humic acid, fulvic acid and humin. Humic substances (HS) are defined by the IHSS (International Humic Substances Society) as complex, heterogeneous mixtures of polydispersed materials formed by biochemical and chemical reactions during the decay and transformation of plant and microbial remains (a process called humification). HS are naturally present in soil, water, peats, brown coals and shales. Traditionally these substances have been isolated into three fractions: humic acid, fulvic acid and humin. These fractions are operationally defined based on solubility in basic and acidic solutions. Leonardite, a brown coal, is known to be rich in humic acid.

In certain embodiments, the VOCERS may optionally comprise one or more additional substances, such as sodium, potassium, ammonium, copper, iron, magnesium, manganese, zinc, calcium, lithium, rubidium or cesium salt of ethylene diamine tetraacetic acid, hydroxyethylene diamine triacetic acid, diethylene triamine pentaacetic acid, nitrillo triacetic acid, and/or ethanol diglycine. In one embodiment, the additional substance is one or more of citric acid, galactaric acid, gluconic acid, glucoheptoic acid, glucaric acid, glutaric acid, glutamic acid, tartaric acid, and tartronic acid. See, e.g., U.S. Pat. No. 4,698,090 at column 3, the disclosure of which is incorporated herein by reference). In some embodiments, the substance (or substances) are present in about 15 total p eight, or from about 5 to about 25 total parts by weight.

A representative VOCERS to be used in the methods provided herein can be prepared according to U.S. Pat. No. 4,698,090. For example, one exemplary VOCERS can be prepared by adding 9 parts (by weight) of leonardite ore to 75 parts of water, previously heated to a temperature of 170° F.-195° F. but to no greater than 225° F. An additional substance, such as one or more of those described above (e.g., potassium tartrate) is added (e.g., 15 parts by weight) and the liquid composition is mixed for five hours and then allowed to settle in multiple stages. Depending upon the desired planting environment, the extracted o liquid may be used in its resulting acidic condition. Alternatively, the pH may be adjusted by adding sodium hydroxide or potassium hydroxide.

In one embodiment, the VOCERS can be prepared by adding 15-22 parts (by weight) of leonardite ore to 30-55 parts of water, previously heated to a temperature of 170° F.-195° F. An additional substance, such as potassium tartrate (9-16 parts by weight) is added. The is liquid composition is oxygenated for a total of 15-300 minutes and a strong base at 5-12 parts is added, followed by the removal of some of the insoluble components of leonardite ore.

In one embodiment, an exemplary volatile organic compound emission reducing substance (VOCERS) comprises disaggregated humin (e.g., from about 2% to about 5%) in a colloidal suspension, as well as humic acid, fulvic acid, and optionally additional active agents and/or additional plant material extracts.

In certain embodiments, the VOCERS is an aqueous composition comprising the humic substances described herein. In such embodiments, the amount of carbon-based component in the VOCERS can ranges from about 5% to about 95% total carbon by weight, or from about 5% to about 85%, or from about 5% to about 75%, or from about 5% to about 65%, or from about 5% to about 55%, or from about 5% to about 45%, or from about 5% to about 35%, or from about 5% to about 25%, or from about 5% to about 15%.

Methods

In one aspect, the present disclosure involves treating the soil of an agricultural, turf or sod grass field or other planting site with a volatile organic compound emission reducing substance (VOCERS) in combination with a fumigant as described herein. The soil to be treated can be any soil type, including, but not limited to, clay, loam, clay-loam, silt-loam, and the like. In some embodiments the soil comprises about 30-70% sand, about 20-60% silt, about 10-25% clay and about 0.5 to 3% organic matter. In some embodiment, the soil comprises about 20-40% sand, about 30-50% silt, about 20-40% clay and about 0.5 to 5% organic matter. In some embodiments, the soil comprises about 40% sand, about 45% silt, about 17% clay and about 3% organic matter or about 40% sand, about 45% silt, about 17% clay and about 3% organic matter or about 30% sand, about 40% silt, about 29% clay and about 1% organic matter, or about 65% sand, about 20% silt, about 14% clay and about 1% organic matter.

It is contemplated that the VOCERS creates a “seal” through which the fumigant or VOCs produced thereby has limited or restricted permeability. Therefore, in certain embodiments, a fumigant is applied to soil before, or just prior to, the VOCERS is applied to the soil. For example, in certain embodiments, the VOCERS is applied to the soil within about one day, or within about 12 hours, or within about 8 hours, or within about 5 hours, or within about 4 hours, or within about 3 hours, or within about 2 hours, or within about 1 hour, or within about 30 minutes, or within about 15 minutes, or within about 10 minutes, or within about 5 minutes, or within about 4 minutes, or within about 3 minutes, or within about 2 minutes, or within about 1 minute of applying the fumigant.

In certain embodiments, the fumigant is chloropicrin. In such instances, the rate at which the chloropicrin is applied to the soil typically varies between about 100 and about 450 pounds of active ingredient per acre. In some embodiments, the chloropicrin is applied at a rate of from about 100 to about 200, or about 120 to about 170, or about 150 pounds of active ingredient per acre. In other embodiments, the chloropicrin is applied at a rate of from about 300 to about 400, or from about 325 to about 375, or about 350 pounds of active ingredient per acre.

In certain embodiments, the fumigant is 1,3-dichloropropene. In such instances, the rate at which the 1,3-dichloropropene is applied to the soil typically varies between about 75 and about 650 pounds of active ingredient per acre. In some embodiments, the 1,3-dichloropropene is applied at a rate of from about 75 to about 110, or about 80 to about 100, or about 90 pounds of active ingredient per acre. In other embodiments, the 1,3-dichloropropene is applied at a rate of from about 450 to about 650, or from about 500 to about 600, or about 560 pounds of active ingredient per acre.

In certain embodiments, the fumigant is dimethyl disulfide. In such instances, the rate at which the dimethyl disulfide is applied to the soil typically varies between about 250 and about 600 pounds of active ingredient per acre. In some embodiments, the dimethyl disulfide is applied at a rate of from about 250 and about 350, or about 275 to about 315, or about 290 pounds of active ingredient per acre. In other embodiments, the dimethyl disulfide is applied at a rate of from about 400 to about 600, or from about 450 to about 550, or about 500 pounds of active ingredient per acre.

In certain embodiments, the fumigant is methyl isothiocyanate. In such instances, the rate at which the methyl isothiocyanate is applied to the soil typically varies between about 100 and about 650 pounds of active ingredient per acre. In some embodiments, the methyl isothiocyanate is applied at a rate of from about 100 and about 150, or about 130 pounds of active ingredient per acre. In other embodiments, the methyl isothiocyanate is applied at a rate of from about 450 to about 650, or from about 500 to about 550, or about 525 pounds of active ingredient per acre.

In certain embodiments, the fumigant is allyl isothiocyanate. In such instances, the rate at which the allyl isothiocyanate is applied to the soil typically varies between about 50 and about 400 pounds of active ingredient per acre. In some embodiments, the allyl isothiocyanate is applied at a rate of from about 50 and about 100 or about 80 pounds of active ingredient per acre. In other embodiments, the allyl isothiocyanate is applied at a rate of from about 250 to about 400, or from about 300 to about 350, or about 320 pounds of active ingredient per acre.

Exemplary amounts are shown in Table 1, below.

TABLE 1

| | Product use rates | |
|---|---|---|
| | Low rate | High rate |
| | in pounds active | in active |
| Substance | ingredient/acre | ingredient/acre |
| VOCERS (VR-016)* | 1 | 2200 |
| Chlorpicrin | 150 | 350 |
| 1,3-dichloropropene | 90 | 560 |
| Dimethyl disulfide | 290 | 500 |
| Methyl | 130 | 525 |
| isothiocyanate | | |
| Allyl isothiocyanate | 80 | 320 |

*For VOCERS, the use rate is expressed in terms of gallons of VOCERS/acre

In one embodiment, the VOCERS is applied to the soil in combination with a fumigant. In certain embodiments, the fumigant and the VOCERS are pre-mixed in solution prior to the addition to the soil. Accordingly, also provided is a composition comprising a fumigant and a volatile organic compound emission reducing substance (VOCERS). In certain embodiments, the weight/weight ratio of VOCERS to fumigant is from 20:1, 15:1, 10:1, 9:1, 8:1, 7:1, 6:1, 5:1, 4:1, 3:1, 2:1, 1:1, 1:2, 1:5, or 1:10.

Conventional application techniques such as spraying, fertigation or shank injection o may be employed. In certain embodiments, soil has been fertilized (i.e., fertilizer may have been pre-applied to the soil). In certain embodiments, the volatile organic compound emission reducing substance (VOCERS) is applied in combination with a fertilizer (e.g., a nitrogen or phosphorous-based fertilizer). In certain embodiments, the fumigant is applied as a liquid or a granule or other dry formulation. The amount of VOCERS to be applied is is normally expressed in gallons VOCERS per acre. Typical rates are about 1 gallon/acre, about 20 gallons/acre, about 50 gallons/acre, about 100 gallons/acre, about 150 gallons/acre, about 300 gallons/acre, about 1,000 gallons per acre, or about 2,200 gallons/acre.

As described herein, the methods may be performed by applying a fumigant and a VOCERS concurrently or separately at or about the same time, to the soil of the agricultural site being treated.

Fumigants are applied in agricultural soils, typically beneath the soil surface, in liquid or solid form. Then they quickly volatilize within the soil pores (air spaces). This volatile gas is very effective to control soil pathogens, including nematodes, plant disease, and some insects and even weed seeds. Thus, the action of the gas in the soil is very important for efficacy. However, the amount and speed of this gas that leaves the soil surface and enters the atmosphere is not good, because it 1) reduces efficacy; 2) creates potential worker exposure; and 3) pollutes the atmosphere.

In one embodiment, the VOCERS is applied to the soil in an easy to use, economical quantity directly to the soil by means such as spraying, flooding, soil injection or chemigation.

The present disclosure involves treating the soil of an agricultural, turf or sod grass field, or other planting site, including sites being prepared for new plantings, with a fumigant in combination with a VOCERS for restricting the volatilization or emission of a volatile organic compounds (VOCs) (either the fumigant or a VOC produced thereby). The methods described herein may be performed by applying the fumigant and the VOCERS concurrently or separately, at or about the same time (e.g., within about 3, or about 2, or about 1 hour or less of each other). In one embodiment, the fumigant and the VOCERS are pre-mixed in solution prior to the addition to the soil. As described herein, the methods may be performed by applying a fumigant and a VOCERS concurrently or separately at or about the same time, to the soil of the agricultural site being treated.

In one embodiment, provided is a method for reducing a buffer zone. Because it is known that fumigant gases are emitted from the soil surface after application, the U.S. Environmental Protection Agency (EPA) and other pesticide regulatory bodies have developed formulae and rules for ensuring safe fumigant applications. The key concept used to protect people nearby is the buffer zone. As used herein, a “buffer zone” is intended to refer to a specified minimum distance in feet from the perimeter of the fumigant-treated field to bystanders or neighbors, where no fumigant may be applied. Such buffer zones are enforced as part of pesticide regulation law. The buffer zone allows a space for emitted gases to disperse into the atmosphere, reducing potential exposure. However, the buffer zone is a significant cost to the farmer, because she or he may loses the benefit of the fumigant there, when after all the fumigant is being applied to prevent significant damage to the crop, as described above. Provided herein is a method for reducing the buffer zone by at least about 10% comprising applying a volatile organic compound emission reducing substance (VOCERS) and a fumigant to soil or applying a volatile organic compound emission reducing substance (VOCERS) to soil which has been treated with a fumigant, wherein the buffer zone is reduced.

Various factors determine the size of the buffer zone: 1) the chemical fumigant in use (more toxic chemicals require larger buffer zones); 2) the use rate (higher fumigant use rates necessitate larger buffer zones); 3) the size of the treated field (larger fields require larger buffer zones); 4) environmental factors such as soil type and temperature (soils with certain properties and also lower ambient temperatures can reduce buffer zones) and 5) the use of barriers such as tarps (more effective barriers allow smaller buffer zones, because they reduce emissions). So, for a fumigant application where factors 1-4 above are fixed, the type of barrier can reduce the size of the buffer zone. Under the EPA rules, the maximum buffer zone reduction, combining all factors, is 80%, and the maximum reduction associated with the best existing tarps is 60%.

Tarps and other barrier methods are reviewed case-by-case by the appropriate regulatory body, which decides the buffer zone reduction percentage (“credit”) based on the properties of the barrier, especially the mass transfer coeffiecient (MTC). The methods (and compositions) described herein, which have an equivalent or better MTC than most kinds of tarps, contemplates reducing emissions at a level that will allow 15% to 60% buffer zone reduction. Therefore, emissions reducing technologies have a significant value to the farmer.

Using the methods provided herein, is it contemplated that the buffer zone is reduced by at least about 10%, or at least about 20%, or at least about 30%, or at least about 40%, or at least about 50%, or at least about 60%, or from about 10% to about 60%, or from about 20% to about 60%, or from about 30% to about 60%, or from about 40% to about 60%, or from about 50% to about 60%, or from about 10% to about 50%, or from about 20% to about 50%, or from about 30% to about 50%, or from about 40% to about 50%, or from about 10% to about 40%, or from about 20% to about 40%, or from about 30% to about 40%, or from about 10% to about 30%, or from about 10% to about 20%. In certain embodiments, the fumigant is chloropicrin, 1,3-dichloropropene, a methyl isothiocyanate generator (e.g., metam sodium), methyl bromide, dimethyl disulfide, or allyl isothiocyanate. In certain embodiments, the buffer zone is reduced by at least about 40%.

In the methods described herein, the rate of the VOCERS applied to the soil can range from about 1 to about 2,200 gallons per acre. In some embodiments, the VOCERS is applied to the soil in an amount of from about 10 gallons per acre to about 200 gallons per acre, or about 10 gallons per acre, or about 20 gallons per acre, or about 30 gallons per acre, or about 40 gallons per acre, or about 50 gallons per acre, or about 60 gallons per acre, or about 70 gallons per acre, or about 80 gallons per acre, or about 90 gallons per acre, or about 100 gallons per acre, or about 125 gallons per acre, or about 150 gallons per acre, or about 200 o gallons per acre, or about 250 gallons per acre, or about 300 gallons per acre, or about 350 gallons per acre, or about 400 gallons per acre, or about 500 per acre, or about 600 gallons per acre, or about 700 gallons per acre, or about 800 gallons per acre, or about 900 gallons per acre, or about 1,000 gallons per acre.

As shown herein (e.g., see FIG. 2) the percentage of standard fumigants emitted from untreated soil or soil treated with a water only seal is greater when compared to soils treated with a fumigant in conjunction with a VOCERS as described herein (e.g., VR-016). In certain embodiments, the application of a VOCERS as a seal reduced fumigant volatilization approximately 70% compared to untreated soil, especially for highly volatile fumigants, such as chloropicrin, 1,3-dichloropropene and dimethyl disulfide.

In certain embodiments, the emissions of the fumigant (or VOCs) was reduced by least about 50% by weight after at least about 7 days after applying the fumigant. Typical temperatures range from about 15-35° C. In other embodiments, the amount of fumigant loss via volatilization is reduced by up to about 60%, or up to about 70%, or up to about 75%, or up to about 80%, or up to about 90%, or up to about 95% about 7 days after applying the fumigant.

In certain embodiments, the fumigant is selected from chloropicrin, 1,3-dichloropropene, dimethyl disulfide and allyl isothiocyanate.

In certain embodiments, the fumigant is chloropicrin. In certain embodiments, the mass transfer coefficient (MTC) in centimeters/hour of the VOCERS with respect to chloropicrin as detected from the soil surface when chloropicrin is applied to untreated soil is less than or about 0.3. In certain embodiments, emission of the chloropicrin is reduced by least about 70% by weight compared to untreated soil after at least about 7 days after applying the fumigant at a temperature of about 15-35° C. In certain embodiments, emission of the chloropicrin is reduced by least about 50% by weight compared to otherwise untreated wet soil after at least about 7 days after applying the fumigant at a temperature of about 15-35° C.

In certain embodiments, the fumigant is 1,3-dichloropropene. In certain embodiments, the mass transfer coefficient (MTC) in centimeters/hour of the VOCERS with respect to 1,3-dichloropropene as detected from the soil surface when 1,3-dichloropropene is o applied to untreated soil is less than or about 0.4. In certain embodiments, emission of the 1,3-dichloropropene is reduced by least about 65% by weight compared to untreated soil after at least about 7 days after applying the fumigant at a temperature of about 15-35° C. In certain embodiments, emission of the 1,3-dichloropropene is reduced by least about 45% by weight compared to otherwise untreated wet soil after at least about 7 days after applying the is fumigant at a temperature of about 15-35° C.

In certain embodiments, the fumigant is dimethyl disulfide. In certain embodiments, the mass transfer coefficient (MTC) in centimeters/hour of the VOCERS with respect to dimethyl disulfide as detected from the soil surface when dimethyl disulfide is applied to untreated soil is less than or about 0.4. In certain embodiments, emission of the dimethyl disulfide is reduced by least about 70% by weight compared to untreated soil after at least about 7 days after applying the fumigant at a temperature of about 15-35° C. In certain embodiments, emission of the dimethyl disulfide is reduced by least about 40% by weight compared to otherwise untreated wet soil after at least about 7 days after applying the fumigant at a temperature of about 15-35° C.

In certain embodiments, the fumigant is allyl isothiocyanate. In certain embodiments, emission of the allyl isothiocyanate is reduced by least about 60% by weight compared to untreated soil after at least about 7 days after applying the fumigant at a temperature of about 15-35° C. In certain embodiments, emission of the allyl isothiocyanate is reduced by least about 25% by weight compared to otherwise untreated wet soil after at least about 7 days after applying the fumigant at a temperature of about 15-35° C.

In certain embodiments, the fumigant is methyl isothiocyanate. In certain embodiments, the mass transfer coefficient (MTC) in centimeters/hour of the VOCERS with respect to methyl isothiocyanate as detected from the soil surface when a fumigant is applied to untreated soil is less than or about 0.4. In certain embodiments, emission of the methyl isothiocyanate is reduced by least about 75% by weight compared to untreated soil after at least about 7 days after applying the fumigant at a temperature of about 15-35° C.

Conventional application techniques such as direct spraying, flooding, soil injection or chemigation may be employed. The VOCERS can be applied either as a mixture with the fumigant (i.e. contemporaneously) or within a sufficiently short time period, typically not more than about 3 hours before or about 3 hours after application of the fumigant. The VOCERS can also be mixed with water. Application of both the fumigant and the VOCERS within such a time window avoids excessive fumigant volatilization and accomplishes a more effective, efficient and prolonged fumigant retention in the soil.

In certain embodiments, the VOCERS comprises a humic component. Conventionally, humic components have been used exclusively as a soil amendment or fertilizer applied at or subsequent to the time of planting. In the methods described herein, the humic component can be applied to the soil at any point, i.e., either before or after planting. In certain embodiments, the humic component is applied in conjunction with pre-plant fumigation. This is contrary to standard humic substance application, which is typically well after the time a fumigant has been applied to soil.

The VOCERS as described herein may also be used in combination with other liquid and solid emission restricting substances and devices, such as water, salts of thiosulfate, tarps, films, and other soil coverings, made from plastics, polymers, polyethylene, HOPE, resins and similar materials known in the soil fumigation industry to control fumigant volatilization. However, the methods described herein work to mitigate or control fumigant volatilization alone, without the use of additional emission restricting substances or devices. As such, in certain embodiments, the VOCERS as described herein are not used in combination with other liquid or solid emission restricting substance or device.

The depletion rate can be a measure of fumigant loss by any method, for example, the fumigant per se or a volatile decomposition product thereof (i.e., a VOC). In one embodiment, the method comprises applying a VOCERS and a fumigant to soil or applying a fumigant to soil to which a VOCERS has been applied, wherein the emissions of the fumigant was reduced by about 40% to about 80% by weight at about 30 hours after applying the VOCERS and/or fumigant to the soil. In other embodiments, the emissions of the fumigant was reduced by about 40%, or about 45%, or about 50%, or about 55%, or about 60% or about 65%, or about 70%, or about 75%, or about 80% by weight at about 24-36 hours after applying the VOCERS and/or fumigant to the soil.

It is contemplated that the methods described herein reduce the amount of fumigant, including, but not limited to the VOCs in the air and/or water, by about 10%, or about 20%, or about 30%, or about 40%, or about 50%, or about 60%, or about 70%, or about 80%, or o about 90%, or more. Accordingly, also provided herein is a method for reducing air and/or water pollution caused by the use of fumigants in soil.

In certain embodiments, the method comprises applying a VOCERS and/or a fumigant in irrigation water. In this, or any other embodiment described herein, the VOCERS may also reduce the amount of fumigant (or VOC) in irrigation water runoff Accordingly, provided is a method for controlling or reducing fumigant runoff, comprising applying a volatile organic compound emission reducing substance (VOCERS) and a fumigant to soil or applying a volatile organic compound emission reducing substance (VOCERS) to soil which has been treated with a fumigant. It is contemplated that the methods described herein reduce the amount of fumigant in irrigation runoff by about 10%, or about 20%, or about 30%, or about 40%, or about 50%, or about 60%, or about 70%, or about 80%, or about 90%, or more.

### EXAMPLES

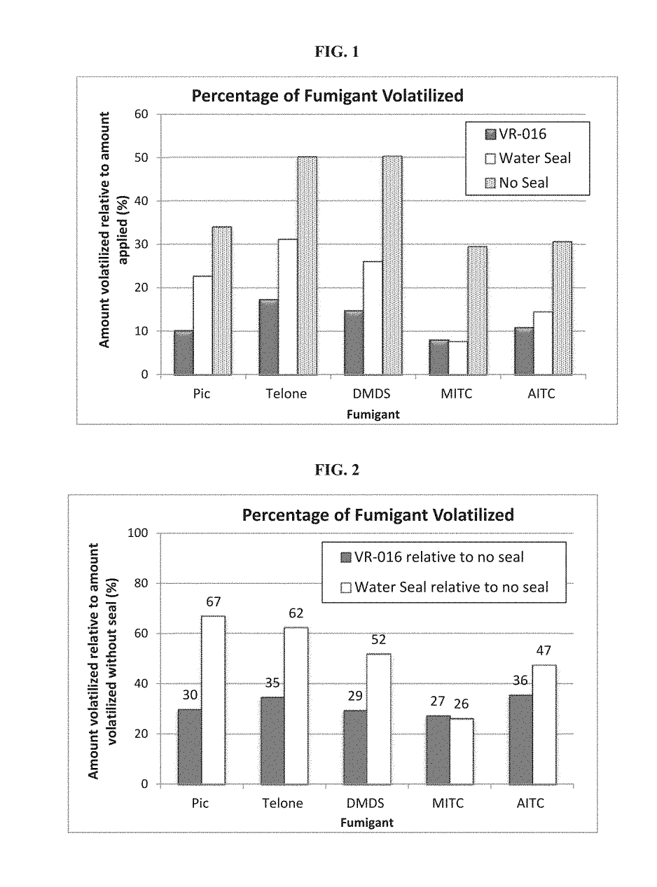

The following examples, as well as graphs and tables shown in FIGS. 1-7, reflect test results that illustrate how treating various samples of fumigated soil with a humic component as described herein acts to control and/or restrict fumigant volatilization and achieve the objects and advantages of this disclosure. In each of the following Examples, the VOCERS used is VR-016, which was prepared as shown below.

VR-016 was prepared by adding 14 parts (by weight) of dry leonardite ore to 52 parts of water, previously heated to a temperature of 185° F. An additional substance, such as potassium tartrate (16 parts by weight), was added and the composition mixed for 2-3 hours. The liquid composition was oxygenated for 270 minutes and 10 parts of a strong base was added followed by the removal of the insoluble components of leonardite ore. The liquid composition was then isolated and pH adjusted with 1 part strong base. VR-016 can be considered either Component 1 or Component 2 (see description above under “Volatile Organic Compound Emission Reducing Substance” and throughout this application).

In each of the following Examples, the soils used are included in the Table 2 below.

TABLE 2

| | | % | % | % | % organic | |
|---|---|---|---|---|---|---|
| Name | Soil series name | Sand | Silt | Clay | matter | pH |
| Tulare | Colpien Loam | 39 | 44 | 17 | 3.1 | 7 |
| Kern | Exeter Sandy Loam | 66 | 21 | 13 | 0.58 | 6.2 |
| Fresno | Cerini Clay Loam | 29 | 41 | 30 | 0.37 | 7.9 |
| Monterey | Pacheco Clay Loam | 31 | 41 | 28 | 1.1 | 7.4 |
| WISC | Milford Silty Clay | 20 | 40 | 40 | 4.1 | 6.6 |
| | Loam | | | | | |
| McCurdy | Tranquillity Clay | 9 | 32 | 60 | 1.6 | 7.8 |
| Elder | Elder sandy loam | 79 | 17 | 4 | 8 g per kg | 7.2 |
| | | | | | soil | |

### Example 1

This example involved a packed column study that simulates shank injection of the

VOCERS into various soil samples treated with assorted soil fumigants. Volatilization levels in samples treated with the fumigants plus the VOCERS were measured and compared against volatilization levels in samples treated with just a water seal and untreated control samples respectively. Volatilization of the fumigants was tested over a three hour period.

The soil samples were collected from the top 15 cm soil level at the California Strawberry Commission Research Facilities near Watsonville (121° 50′ W, 36° 54′ N California, USA). The soil was classified as an Elder sandy loam (a course-loamy, mixed, thermic, Cumulic Haploxeroll), with a mean particle size distribution of 79% sand, 17% silt and 4% clay. The soil had a pH of 7.2 (H₂O). The organic carbon content of the soil was 8 g per kg soil. The sandy loam soil was selected because it is a typical soil on which much of the strawberry and cut flower production occurs in California. Moist field soil was air dried (approximately 3% moisture by weight) and passed through a 2 mm sieve prior to the test.

The fumigants treating the soil and being tested in Example 1 were methyl bromide (MeBr), chloropicrin (CP), 1,3-dicholorpropene (1,3-D), dimethyl disulfide (DMDS), allyl isothiocyanate (AITC), methyl isothiocyanate (MITC), and metam sodium (a MITC generator).

Laboratory tests were conducted using soil packed, stainless steel columns (30 cm high×12.5 i.d.) to determine the dissipation of the fumigants introduced into the soil by a sandy loam soil shank injected at 4 inches (10 cm) soil depth. Three soil sample columns were prepared for each fumigant. The soil in a first one of the columns was first treated and sealed with 10 mm of water containing/mixed with the VOCERS. A second column was treated and sealed with 10 mm of water alone. In both cases, the 10 mm included the equivalent to 100 gallons of VR-016 per acre.

In each group of three soil test columns the third column was left untreated to serve as a control. Each of the treated/sealed and untreated/unsealed columns was then closed by gluing a head space cap onto the column using resin epoxy and aluminum tape. Immediately after capping was completed, 30 microliters of each of the tested fumigants was injected into a respective soil column through a gas-tight syringe. The fumigant concentration at the injection point and in the head space above the soil was then measured in each column every 30 minutes for three hours using a high speed micro gas chromatograph (i.e. an Agilent 3,000 A micro Ge).

Fumigant emission was measured in the respective soil columns over the course of the three hour test period. FIG. 1 shows the percentage of each fumigant emitted relative to the amount of fumigant applied over the period of 3 hours following injection of the fumigant into the respective soil sample. More specifically, the graph illustrates the volatilization (emission) percentage for each fumigant injected into soil treated with the water VOCERS mixture and the water only. The green bar depicts the percentage of volatilization for each fumigant injected into the untreated soil. It should be noted that in the accompanying graphs “VR-016” refers to soil treated with the VOCERS and water, “water seal” refers to the soil treated with water alone and “no seal” refers to untreated control soil samples.

As is shown in FIG. 1, the soil samples treated with the VOCERS reduced emissions significantly compared to that exhibited by untreated soil samples. This applies for each of the tested fumigants. Indeed, the soil treated with VOCERS exhibited significantly less emission than soils treated with the water seal alone for virtually all of the tested fumigants. Only for MITC are the VR-016 and water seal volatilization levels comparable.

FIG. 2 shows the percentage of each fumigant volatilized (emitted) from soils featuring the water only seal and the VR-016, respectively, relative to the amount of that fumigant volatilized from the untreated control soil. These results illustrate that the application of the VOCERS as a seal reduces fumigant emissions approximately two-thirds, especially for highly volatile fumigants, such as chloropicrin and DMDS.

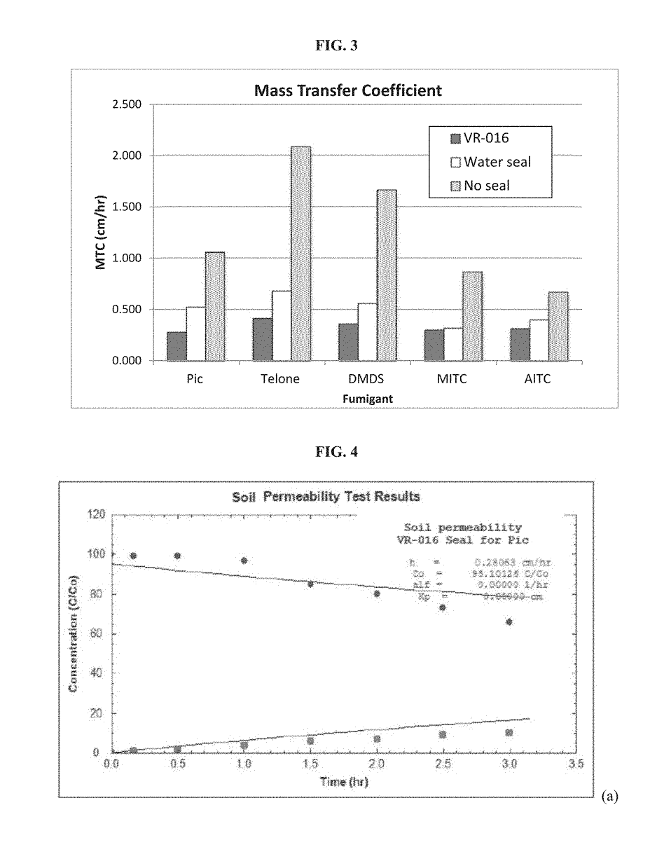

FIG. 3 represents the mass transfer coefficient (MTC) exhibited by each of the three test samples for each fumigant in Example 1. MTC refers to the speed at which the fumigant (or VOC) escapes from the soil and into the air. A smaller MTC is indicative of slower movement or flow and thus longer and more effective retention of the fumigant within the soil. The MTC of the fumigant injected into the soils treated by the VOCERS (i.e. VR-016) is clearly less than the MTC for either the soils treated by a water seal and the untreated soils for virtually all fumigants. This indicates that use of a VOCERS significantly slows the flow of fumigant and delays dissipation of the fumigant into the atmosphere. It is contemplated that fumigant flow is significantly slowed by use of a VOCERS acting as a cap or seal in the soil. As discussed above, MTC can be used to determine buffer zone reductions for fumigant barriers.

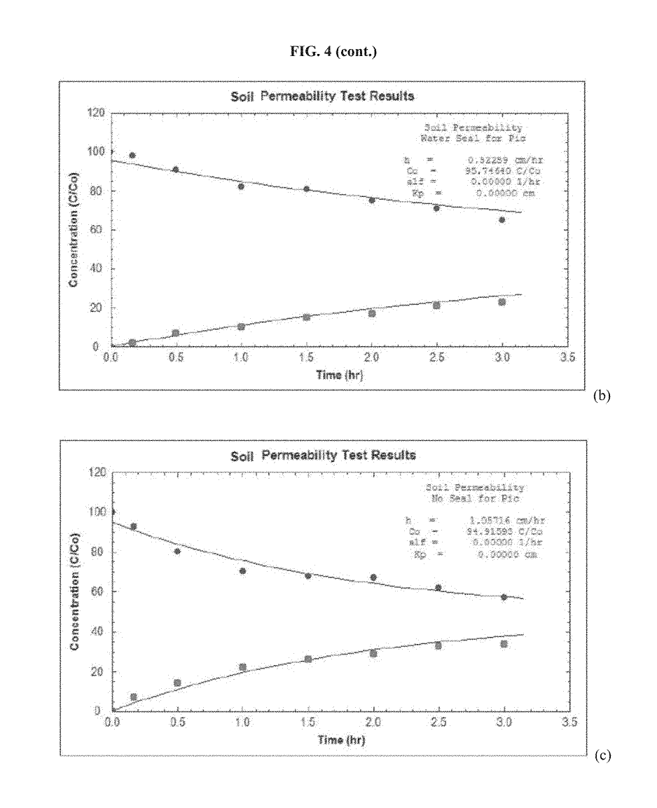

FIGS. 4A-C particularly depict the soil permeability measurements exhibited for the fumigant chloropicrin (CP) through the two treated soils and the untreated control soil, respectively. In each graph, the top line reflects the ratio of the measured concentration C of the fumigant chloropicrin beneath the soil relative to the initial applied fumigant concentration (Cₒ) and as measured over the three hour test period. The bottom line of each graph reflects, in a complementary manner, the percentage of the detected concentration (C) of chloropicrin in the air above the soil, again at selected time intervals during the three hour test period, relative to the applied fumigant concentration (Cₒ). Measurements were obtained for the VR-016 seal, the water seal and the untreated control, FIGS. 4A-4C, respectively, using FILM PC software as described by Papiernick et al. (2001 “An Approach For Estimating The Permeability of Agricultural Films” Environ. Sci. Technol. 35, 1240-1246). As clearly shown in FIGS. 4A-4C, for each type of treatment, the relative subsurface and above surface concentration percentage levels converge over time for each sample tested, regardless of whether or not the sample was treated by a seal and likewise regardless of the type of seal involved. Nonetheless, the convergence is much more gradual when a VOCERS is employed as a seal. This indicates that by using this substance, the fumigant emission is restricted and controlled. As a result, the fumigant is more effectively retained for a longer period of time in the soil.

### Example 2

This test involved a vial study simulating fumigants applied together in a mixture also containing water and a VOCERS as a subsoil fumigation treatment. This test was specifically intended to evaluate the efficacy of using a VOCERS in a chemigation process wherein the fumigant and the humic component are mixed and applied to the soil together in order to suppress fumigant emission from the soil after chemigation. For each fumigant, four sealed vials were prepared. Soils, soil preparation techniques and fumigants were the same as those employed in Example 1. For each fumigant, the four vials were prepared and treated as follows:
1. Fumigant plus water (Control 1);
2. Fumigant plus water plus VR-016 (control 2);
3. Fumigant plus water plus soil; and
4. Fumigant plus VR-016 plus water plus soil.

Each treatment included 30 microliters of each fumigant mixed with 30 ml of water. Treatments 2 and 4 also included 10% concentration of the VOCERS component in the water, or about 2,100 gallons VR-016 per acre. Each of treatments 3 and 4 included 100 g soil. Each vial was immediately sealed and the concentration of the fumigant in that vial's head space above the soil was measured using the gas chromatograph specified in Example 1.

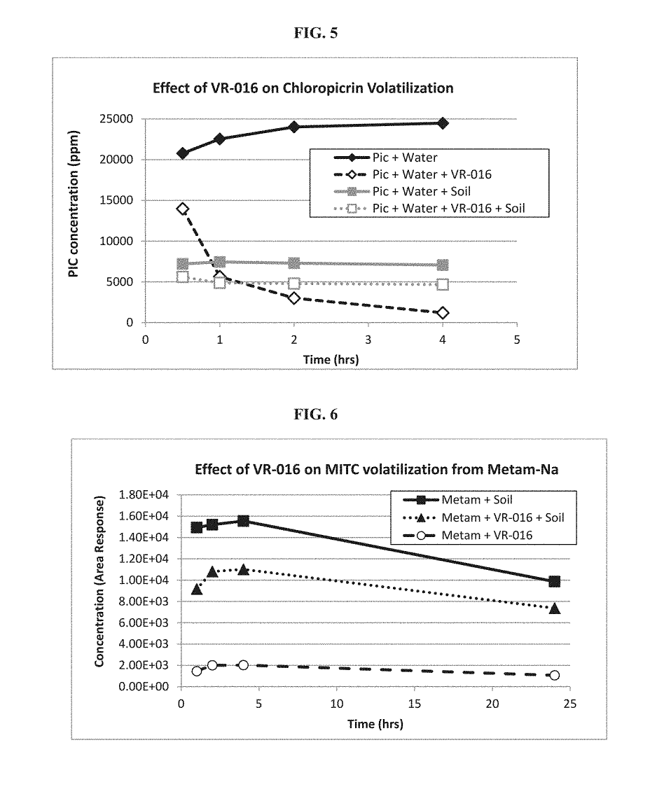

The volatility of the fumigants were evaluated in the closed vials over a four hour period. FIG. 5 depicts the volatility results as measured by fumigant concentration levels, over a four hour period for the fumigant chloropicrin (Pic). As shown therein, adding a VOCERS to water reduced chloropicrin (Pic) emissions by approximately 95%. In soil, the VOCERS suppressed the volatility of the chloropicrin (Pic) by approximately 33%. Application of a VOCERS to irrigation water containing fumigants suppressed the volatility of all fumigants from the irrigation water and from the soil surface.

### Example 3

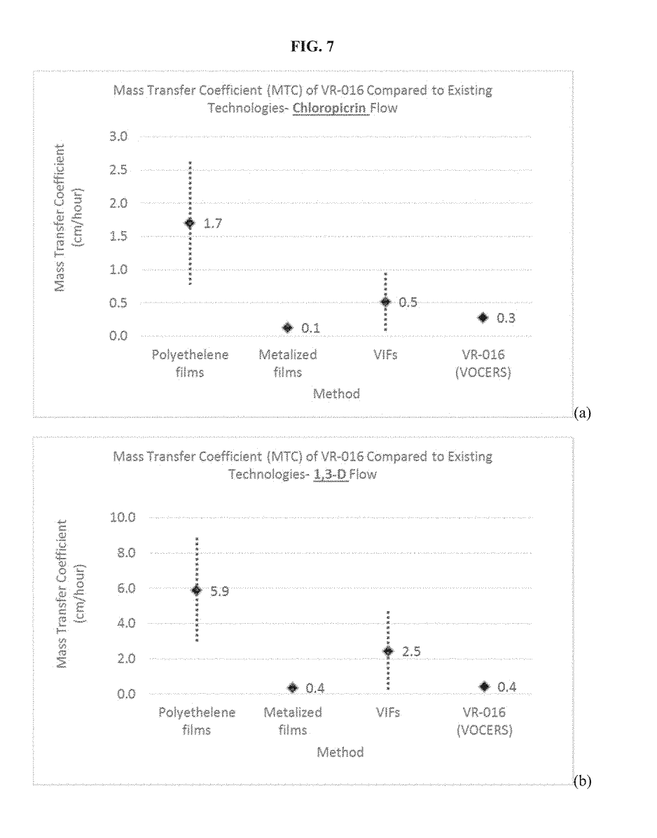

The volatility of methyl isothiocyanate (MITC) generated from metam-Na was o evaluated by testing the results of the treatments over a period of four hours. Metam-Na plus soil was added to a first vial. Metam-Na plus a VOCERS and soil were added to a second vial; and metam-Na and VR-016 were added to a third vial. Metam-Na was applied at the same rate as VR-016 (1:1 ratio by volume), which was equivalent to 70 gallons per acre. The top line in FIG. 6 shows the changes in concentration and thus the volatility over time when metam-Na was applied to soil without any additional treatment. The middle line reflects the application of VR-016 to the soil, which is a 25% reduction in gas emission after 24 hours compared to the top line. The bottom line represents the volatilization of metam-Na and VR-016 applied in combination. As is clearly shown, approximately 80% less methyl isothiocyanate was generated in the head space, compared to Line 5, after the VOCERS was utilized during a comparable period of time. Once again, this test discloses that application of a VOCERS to the fumigated soil effectively prolongs the presence of fumigants within the soil so that more effective fumigation is achieved.

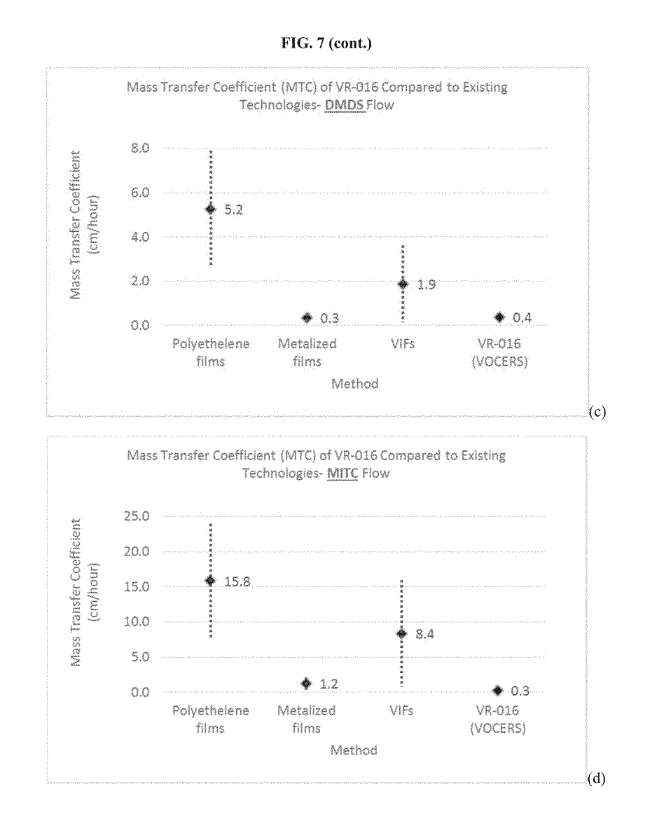

FIG. 7 compares the mass transfer coefficients of various fumigants treated with the humic component as described herein and compared against the mass transfer coefficients previously recorded using similar methods when various types of conventional films are utilized to control fumigant volatilization as practiced in the prior art. In particular, the results that were derived in the foregoing tests of Examples 1 show that the mass transfer coefficients and accordingly the corresponding flow rates are much smaller than the mass transfer coefficients exhibited when polyethylene films are employed to control fumigant emission. Emission control/reduction by VOCERS is superior to the other methods shown, except metalized films, which have MTCs comparable to VOCERS. Therefore, it can be stated that the method of the present methods are equivalent, or even superior, to most film types in many if not most applications (one type of film evaluated by Qian et al, “Totally Impermeable Films” or TIF, which are very costly, are superior to the other film types). Applying agricultural films to a field consumes considerable resources, significant hours of human labor, and requires sophisticated agricultural machinery. Moreover, large volumes of costly film must be stored and transported to and from the agricultural site, and then disposed days after the treatment is made.

In contrast, fumigated agricultural fields may be treated with the VOCERS of this disclosure in liquid form. The application process is typically easier, less complicated, far less o expensive, and can be more effective in reducing emissions. The labor and equipment costs, as well as the storage, transport, cost and other logistic problems associated with film and tarp techniques are avoided. By the same token, FIG. 7 illustrates that emission is controlled by the methods disclosed herein in a manner virtually comparable to the use of metalized films of the prior art. The only fumigant tested for which there appears to be a significant is volatility disadvantage is methyl bromide. However, as previously indicated, the use of that fumigant has largely been discontinued. As a result, its relatively high mass transfer coefficient value is less relevant.

Overall, the advantages of using the VOCERS as a sealing treatment or cap to control and restrict fumigant volatilization or emission from the soil surface makes the use of that method significantly advantageous over conventional film and tarp techniques.

Practicing the method of this invention improves fumigant retention in the soil. As a result, the fumigant acts far more effectively to attack and kill soil pests and pathogens. At the same time, because hazardous and potentially polluting vapor emissions are reduced, the size of untreated buffer zones surrounding untreated areas can be substantially reduced.

The present method greatly improves fumigant effectiveness and efficiency without requiring the complexity, time, labor, equipment, materials and attendant expense involved with conventional techniques. As one example, the manufacture of film tarps comprising polyethylene and other synthetic polymers contributes to greenhouse gas emissions, and also to solid waste disposal issues. Avoiding the use of such products is highly beneficial to both the grower and consumers as currently available fumigants may be used even more effectively and safely than in the past.

The VOCERS also has improved ability, because of its location in the soil, compared to films, tarps and other coverings, which are necessarily located above the soil surface, for help keeping the fumigants in the soil, where their efficacy is required on soil pests which live below the soil surface, not above it.

From the foregoing, it may be seen that this invention provides a method for controlling and reducing the emission of volatile organic compounds from a fumigant treated soil. The method prolongs the retention of fumigant within the soil and therefore improves the effectiveness of the fumigant in attacking and killing pests and pathogens. At the same time, adverse safety, health and environmental concerns diminish due to reduced volatilization from the soil. Much less of the applied fumigant is wasted and smaller amounts of fumigant are therefore required. This further reduces costs to both the grower and the consumer.

While this detailed description has set forth particularly preferred embodiments of the method of this disclosure, numerous modifications or variations of the method of this disclosure, all within the scope of this disclosure will readily occur to those skilled in the art.

What is claimed is:

1. A method for controlling or reducing emission of a volatile organic compound (VOC) from soil, comprising applying a volatile organic compound emission reducing substance (VOCERS) and a fumigant to soil or applying a volatile organic compound emission reducing substance (VOCERS) to soil which has been treated with a fumigant, wherein the emission of the VOC is reduced by least about 50% by weight compared to untreated soil after at least about 7 days after applying the fumigant at a temperature of about 15-35° C.

2. The method of claim 1, wherein the emission of the volatile organic compound (VOC) is reduced by up to about 60% after about 7 days after applying the fumigant.

3. The method of any preceding claim, comprising applying a VOCERS to soil at a rate of at least about 20 to about 2,200 gallons of VOCERS per acre of soil.

4. The method of any preceding claim, wherein the VOCERS and the fumigant are applied to the soil in an amount of from about 20 gallons of VOCERS per 100 gallons of fumigant to about 150 gallons of VOCERS per 100 gallons of fumigant.

5. The method of any preceding claim, wherein the VOCERS is applied to the soil within about 3 hours after applying a fumigant.

6. The method of any preceding claim, wherein the VOCERS is applied to the soil at substantially the same time as the fumigant.

7. The method of any preceding claim, wherein the VOCERS and the fumigant are pre-mixed prior to applying.

8. The method of any preceding claim, wherein the VOCERS is applied to the soil by spraying, flooding, soil injection or chemigation.

9. The method of any preceding claim, wherein the VOCERS is applied to the soil in an aqueous composition via irrigation.

10. A method for controlling or reducing emission of a volatile organic compound (VOC) from soil, comprising applying a volatile organic compound emission reducing substance (VOCERS) and a fumigant to soil or applying a volatile organic compound emission reducing substance (VOCERS) to soil which has been treated with a fumigant, wherein the mass transfer coefficient (MTC) in centimeters/hour of the VOCERS with respect to VOC as detected from the soil surface when fumigant is applied to untreated soil is less than or about 0.4.

11. The method of any preceding claim, wherein the fumigant is chloropicrin, 1,3-dichloropropene, a methyl isothiocyanate generator, methyl bromide, dimethyl disulfide, or allyl isothiocyanate.

12. The method of claim 10, wherein the methyl isothiocyanate generator is metam sodium.

13. The method of claim 10, wherein the fumigant is chloropicrin.

14. The method of claim 13, wherein the mass transfer coefficient (MTC) in centimeters/hour of the VOCERS with respect to chloropicrin as detected from the soil surface when 1,3-dichloropropene is applied to untreated soil is less than or about 0.3.

15. The method of claim 13, wherein the emission of the chloropicrin is reduced by least about 70% by weight compared to untreated soil after at least about 7 days after applying the fumigant at a temperature of about 15-35° C.

16. The method of claim 11, wherein the fumigant is 1,3-dichloropropene.

17. The method of claim 16, wherein the mass transfer coefficient (MTC) in centimeters/hour of the VOCERS with respect to 1,3-dichloropropene as detected from the soil surface when 1,3-dichloropropene is applied to untreated soil is less than or about 0.4.

18. The method of claim 16, wherein the emission of the 1,3-dichloropropene is reduced by least about 65% by weight compared to untreated soil after at least about 7 days after applying the fumigant at a temperature of about 15-35° C.

19. The method of claim 11, wherein the fumigant is dimethyl disulfide.

20. The method of claim 19, wherein the mass transfer coefficient (MTC) in centimeters/hour of the VOCERS with respect to dimethyl disulfide as detected from the soil surface when dimethyl disulfide is applied to untreated soil is less than or about 0.4.

21. The method of claim 19, wherein the emission of the dimethyl disulfide is reduced by least about 70% by weight compared to untreated soil after at least about 7 days after applying the fumigant at a temperature of about 15-35° C.

22. The method of claim 11, wherein the fumigant is allyl isothiocyanate.

23. The method of claim 22, wherein the emission of the allyl isothiocyanate is reduced by least about 60% by weight compared to untreated soil after at least about 7 days after applying the fumigant at a temperature of about 15-35° C.

24. The method of claim 11, wherein the fumigant is methyl isothiocyanate or a methyl isothiocyanate generator.

25. The method of claim 24, wherein the mass transfer coefficient (MTC) in centimeters/hour of the VOCERS with respect to methyl isothiocyanate as detected from the soil surface when methyl isothiocyanate or a methyl isothiocyanate generator is applied to untreated soil is less than or about 0.4.

26. The method of claim 24, wherein the emission of the methyl isothiocyanate is reduced by least about 75% by weight compared to untreated soil after at least about 7 days after applying the fumigant at a temperature of about 15-35° C.

27. The method of any preceding claim, wherein the method does not further comprise applying an agricultural film to the soil.

28. A method for reducing a buffer zone, comprising applying a volatile organic compound emission reducing substance (VOCERS) and a fumigant to soil or applying a volatile organic compound emission reducing substance (VOCERS) to soil which has been treated with a fumigant, wherein the buffer zone is reduced by at least about 10%.

29. The method of claim 28, wherein the buffer zone is reduced by at least about 20%.

30. The method of claim 28, wherein the fumigant is chloropicrin, 1,3-dichloropropene, a methyl isothiocyanate generator, methyl bromide, dimethyl disulfide, or allyl isothiocyanate.

31. The method of claim 30, wherein the methyl isothiocyanate generator is metam sodium.

32. The method of claim 30 or 31, wherein the buffer zone is reduced by at least about 40%.

33. A composition comprising a fumigant and a volatile organic compound emission reducing substance (VOCERS).

34. The composition of claim 33, wherein the composition comprises from about 20% to about 50% VOCERS and from about 80% to about 50% fumigant.

35. The method of any preceding claim, wherein the VOCERS is a humic substance (HS).

36. The method of any preceding claim, wherein the VOCERS is a humic substance (HS) comprising humic acid, fulvic acid and humin.

37. The method of any preceding claim, wherein the VOCERS is an aqueous composition comprising from about 5% to about 25% of a humic substance (HS).

38. A method for controlling or reducing fumigant runoff, comprising applying a volatile organic compound emission reducing substance (VOCERS) and a fumigant to soil or applying a volatile organic compound emission reducing substance (VOCERS) to soil which has been treated with a fumigant.

39. A method for controlling or reducing air and/or water pollution caused by the use of fumigants in soil, comprising applying a volatile organic compound emission reducing substance (VOCERS) and a fumigant to soil or applying a volatile organic compound emission reducing substance (VOCERS) to soil which has been treated with a fumigant.
